(19) United States
(12) Patent Application Publication
(10) Pub. No.: US 2023/0237371 A1
(43) Pub. Date: Jul. 27, 2023

(54) SYSTEMS AND METHODS FOR PROVIDING PREDICTIONS WITH SUPERVISED AND UNSUPERVISED DATA IN INDUSTRIAL SYSTEMS

(71) Applicant: Rockwell Automation Technologies, Inc., Mayfield Heights (US)

(72) Inventors: Meiling He, Shorewood, WI (US); Francisco P, Maturana, Lyndhurst, OH (US); Dennis J. Luo, Germantown, WI (US); Robert Nunoo, Mundelein, IL (US); Jay W. Schiele, Shorewood, WI (US)

(21) Appl. No.: 17/661,408

(22) Filed: Apr. 29, 2022

Related U.S. Application Data
(60) Provisional application No. 63/267,135, filed on Jan. 25, 2022.

(51) Int. Cl. G06N 20/00

(52) U.S. Cl. CPC G06N 20/00

(57) ABSTRACT

Various embodiments relate to systems and methods for providing machine learning of supervised and unsupervised data by: receiving a set of industrial data associated with one or more industrial components within an industrial system; generating a classification for each of the set of industrial data using each of a set of models; generating an evaluation value for each of the set of models based on the classifications for each industrial data; and selecting one or more models according to the evaluation values.

### CROSS-REFERENCE TO RELATED APPLICATIONS

This application is a utility of, and claims priority to, U.S. Patent Provisional Application No. 63/267,135, filed on Jan. 25, 2022 entitled “SYSTEMS AND METHODS FOR PROVIDING MACHINE LEARNING WITH SUPERVISED AND UNSUPERVISED DATA IN SMART MANUFACTURING” which is incorporated by reference herein in its entirety for all purposes.

### BACKGROUND

The subject matter disclosed herein relates generally to industrial systems and methods for provide data analysis, and more particularly, for providing predictions through machine learning with supervised and unsupervised data.

Industrial systems used for various industrial fields such as smart manufacturing generate enormous amount of industrial data. These industrial data may be related to the growing applications of sensors in manufacturing lines, the collection of environmental data, and the increased access to various machine parameters. The industrial data can be used in various data processing tools for diagnostics and prognostics in the industrial system.

### Overview

This Overview is provided to introduce a selection of concepts in a simplified form that are further described below in the Detailed Description.

In an implementation, provided is a non-transitory or tangible computer-readable medium storing computer-executable instructions. The non-transitory computer-readable storage medium can have stored thereon computer-executable instructions that, in response to execution, cause a computing device including a processor to perform operations. The operations include receiving a set of industrial data associated with one or more industrial components within an industrial system; generating a classification for each of the set of industrial data using each of a set of models; generating an evaluation value for each of the set of models based on the classifications for each industrial data; and selecting one or more models according to the evaluation values.

In another embodiment, a method includes receiving a set of industrial data associated with one or more industrial components within an industrial system; generating a classification for each of the set of industrial data using each of a set of models; generating an evaluation value for each of the set of models based on the classifications for each industrial data; and selecting one or more models according to the evaluation values.

In another embodiment, a system includes a memory that stores executable components and a processor, operatively coupled to the memory, that executes the executable components. The executable components include receiving a set of industrial data associated with one or more industrial components within an industrial system; generating a classification for each of the set of industrial data using each of a set of models; generating an evaluation value for each of the set of models based on the classifications for each industrial data; and selecting one or more models according to the evaluation values.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an exemplary process 100 for providing machine learning of industrial data of an industrial system according to some embodiments;

FIG. 2 illustrates an exemplary process 200 for selecting a machine learning model for supervised industrial data according to some embodiments;

FIG. 3 illustrates an exemplary process 300 for selecting a machine learning model for unsupervised industrial data according to some embodiments;

FIG. 4 illustrates an exemplary process 400 for generating a set of industrial data for machine learning according to some embodiments;

FIG. 5 illustrates a block diagram of a computer operable to execute the disclosed aspects according to some embodiments; and

FIG. 6 illustrates a schematic block diagram of an illustrative computing environment for processing the disclosed architecture in accordance with another aspect.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Industrial data usually includes supervised data and unsupervised data for machine learning process. Each supervised data includes one or more identifiers (e.g., labels) that can identify raw data (e.g., images, text files, videos, etc.) and identify one or more characteristics of the data source (e.g., one or more corresponding industrial components). For example, one or more identifiers of the supervised data may identify an abnormal operating condition/status of one or more corresponding industrial components. The abnormal operation condition/status may be identified as outliers within a dataset. In another example, the one or more identifiers may indicate whether a motor is broken based on the sensor data, or if an x-ray image contains a tumor. The one or more identifiers may be created by human labelers or any automatic label means. For example, one or more identifiers may be created by labelers tagging all the images in a dataset where “do the photo contain a bird” as true. Unsupervised data refers to data that does not include identifiers that can identify one or more user requested characteristics of the data source for machine learning. For example, unsupervised data may include one or more identifiers that identify a component name/ID of the data source. However, the unsupervised data does not include one or more identifiers that can identify an abnormal operating condition for an anomaly detection machine learning process.

Traditional machine learning (ML) has achieved considerable successes in recent years and an ever-growing number of disciplines rely on it. However, the traditional ML crucially relies on human machine learning experts to perform manual tasks. As the complexity of these tasks is often beyond non-ML-experts, the rapid growth of machine learning applications has created a demand for off-the-shelf machine learning methods that can be used easily and without expert knowledge. AutoML has been since developed to provide progressive automation of machine learning. The present disclosure relates to systems and methods for applying a novel automated ML framework to industrial streaming data which often has imbalance data distribution and requires experts to perform manual feature engineering. The systems and methods can select best machine learning model for both supervised and unsupervised learning models. The systems and methods can also auto detect the imbalance industrial data, auto address the imbalance data pattern, and auto apply the best ML model without human ML experts to performance the manual tasks. The selected best machine learning model can be used to make prediction (e.g., anomaly detection) on raw data. The systems and methods utilize different machine learning frameworks for the supervised data and unsupervised data. In this way, the present disclosure provides a more accurate algorithm for detecting abnormal behavior in the industrial system through machine learning. The abnormal behavior can include any user defined behavior (e.g., user unfavored machine behavior) and any abnormal, faulty, attacking events of the industrial system, such as abnormal operating conditions, abnormal control procedures, abnormal communication systems, abnormal generated products, etc. In some embodiments, the systems and methods may enable a software as a service (SaaS) solution, which allows the commercial engineers and/or customers to implement or develop customized prediction applications. In some embodiments, the systems and methods may enable a single pane of glass (SPOG) solution, which allows the commercial engineers and/or customers to subscribe to the service. The systems and methods can provide more efficient data processing and reduce labor time by reducing duplicated data processing.

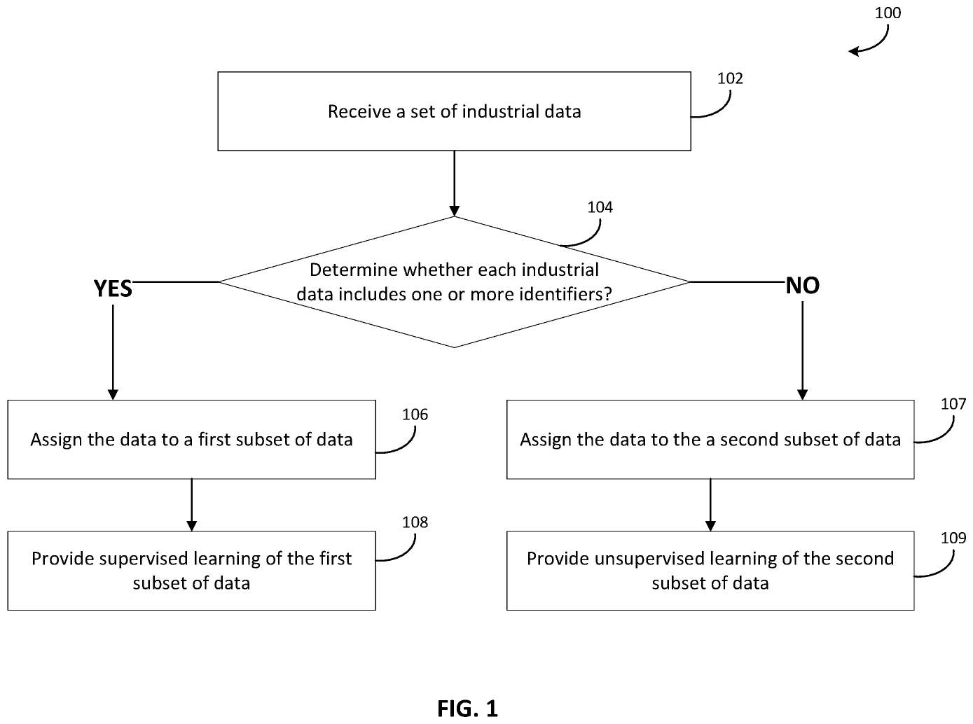

FIG. 1 illustrates an exemplary process 100 for providing machine learning of industrial data of an industrial system according to some embodiments. The process 100 can be operated by any industrial analytics systems, such as, artificial intelligent engines, analytics engines, etc. At step 102, a set of industrial data is received. The set of industrial data can be any data received from various machines and/or components of the industrial system. The industrial data can include both historical data and real-time data.

At step 104, the industrial analytics systems determine whether each industrial data is supervised or unsupervised by determining whether each industrial data includes one or more identifiers. The one or more identifiers can be used to identify one or more operating conditions or events of the data source for the machine learning. The one or more operating conditions or events are defined as the purpose of the machine learning. For example, if the machine learning process is for detecting anomaly, the one or more identifiers may be used for identifying abnormal behaviors of the data source.

At step 106, upon determining that a data is supervised (e.g., including one or more identifiers), the industrial analytics systems assign the data to a first subset of data. At step 107, upon determining that a data is unsupervised (e.g., not including one or more identifiers), the industrial analytics systems assign the data to a second subset of data.

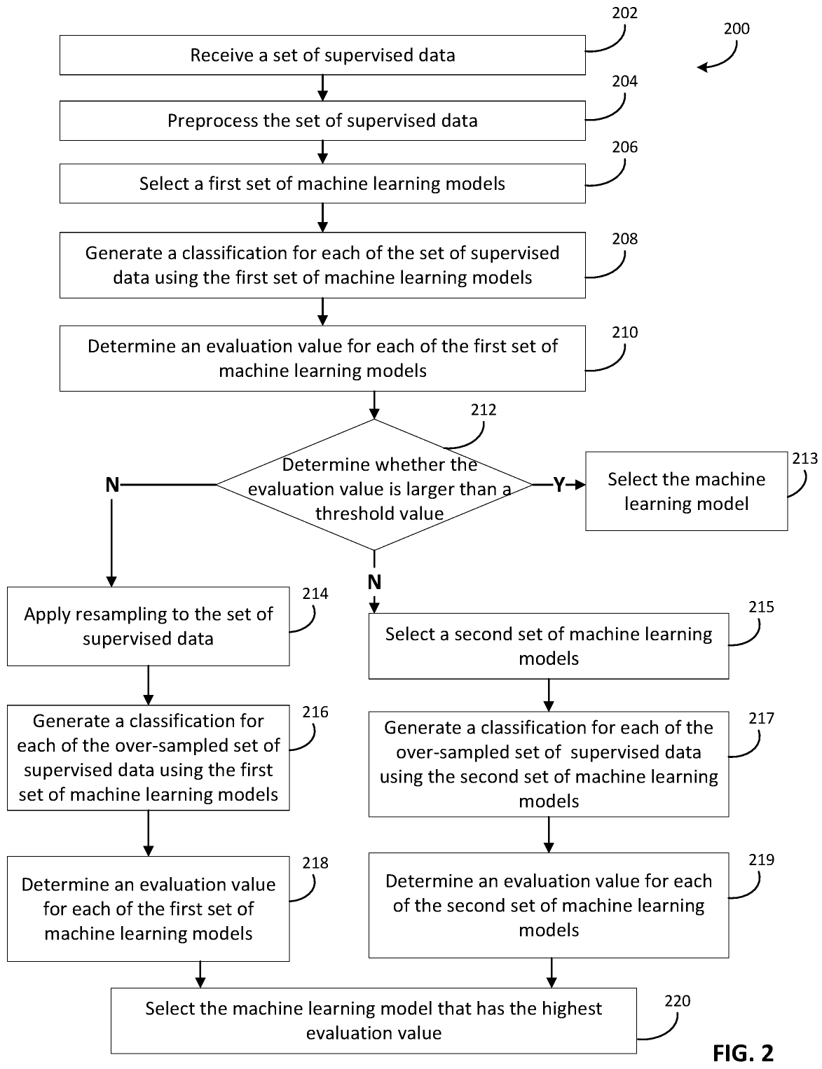

At step 108, the industrial analytics systems provide supervised learning of the first subset of data by processing the first subset of data using a supervised machine learning model. The supervised machine learning model is selected by a supervised learning framework as described in FIG. 2. For example, the first subset of data consists a matrix X∈ [symbol] ^{n×d} as

X={xᵢ^{d}}ᵢ₌₁ⁿ

and a one dimensional binary labeled vector y (e.g., identifiers) as:

y={yᵢ}ᵢ₌₁ⁿ

xᵢ^{d} is the i^{th} observation of d dimensional sample data and yᵢ∈{0,1} is the corresponding label that indicates to which classification xᵢ^{d} belongs.
Supervised learning can be formulated as:

[symbol]

={(xᵢ^{d},yᵢ)|xᵢ^{d}∈ [symbol] ^{d},yᵢ∈{0,1}}ᵢ₌₁ⁿ

The objective of the supervised learning is to find an optimized and generalized transformation [symbol] of input X to the output labels y based on certain evaluation metrics that minimize the error between y and ŷ:

[symbol]

(X)=ŷ

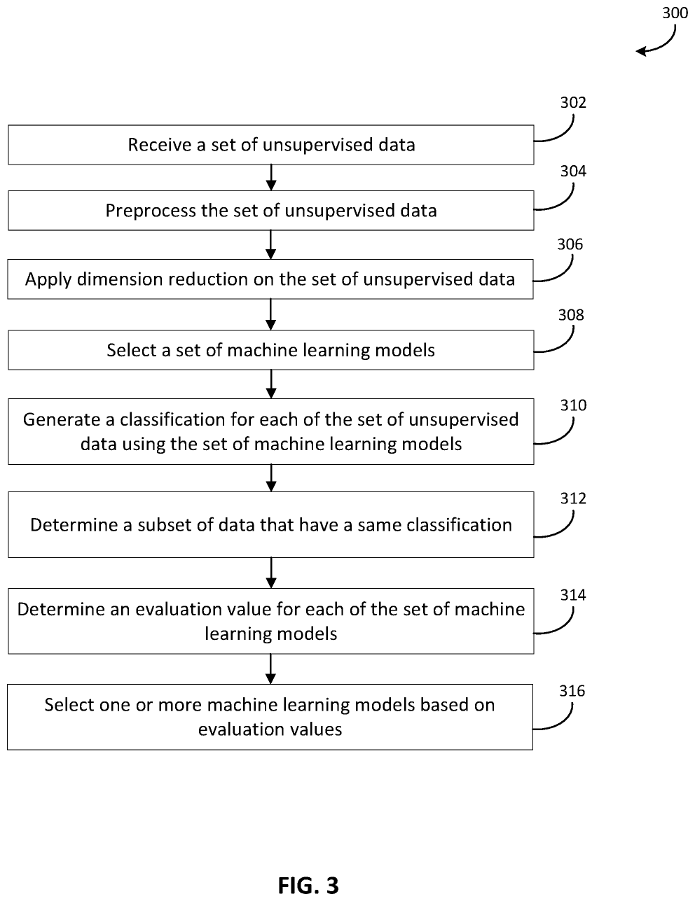

At step 109 the industrial analytics systems provide unsupervised learning of the second subset of data by processing the second subset of data using an unsupervised machine learning model. The unsupervised machine learning model is selected by an unsupervised learning framework as described in FIG. 3. In some embodiments, the step 108 and the step 109 can be processed at the same time in parallel. In some embodiments, the industrial analytics systems may provide unsupervised learning of the set of industrial data. For example, when the size of the first subset of data is much smaller than the size of the second subset of data, the industrial analytics systems may provide unsupervised learning to the whole set of industrial data. In some embodiments, the industrial analytics systems may skip the steps 104, 106, 107 and 108 and directly apply unsupervised learning to the whole set of industrial data.

FIG. 2 illustrates an exemplary process 200 for selecting a machine learning model for supervised industrial data. The process 200 can be operated by any industrial analytics systems, such as, artificial intelligent engines, analytics engines, etc. At step 202, a set of supervised data is received. Each of the set of supervised data includes one or more identifiers that can be used to identify one or more operating conditions or events of the data source for the machine learning. The one or more operating conditions or events are defined as the purpose of the machine learning. For example, if the machine learning process is for detecting anomaly, the one or more identifiers may be used for identifying abnormal behaviors of the data source. In another example, if the machine learning process is for predicting operations of the industrial system, the one or more identifiers may be used for predicting corresponding operating behaviors. Each supervised data includes both categorical and numerical information. For example, the categorical information may be presented by the one or more identifiers.

At step 204, the set of supervised data is preprocessed. In some embodiments, the step 204 may be omitted. All the categorical information of the supervised data may be converted to numerical information. For example, if a categorical information of a data indicates a good condition, this categorical information is converted to a numerical value 0. If a categorical information of another data indicates a bad condition, this categorical information is converted to a numerical value 1. In another example, if a categorical information of a data indicates that the gate is open, this categorical information is converted to a numerical value 1. If a categorical information of another data indicates that the gate is closed, this categorical information is converted to a numerical value 0. In addition, the set of supervised data is filtered to include only the supervised data with user interested and/or related features. If each data of the set of data includes multiple dimensions, the related dimensions (e.g., features) may be selected and the unrelated dimensions may be removed from the set of data. For example, each data has six values including two values of temperature measurements from two temperature sensors and four values of pressure measurements from four temperature sensors. If the pressure measurements are the interested features, the two temperature values may be removed from the data. In this way, the data only includes interested values (e.g., features) to improve the modeling efficiency and accuracy. In some embodiments, the related supervised data may be selected using Pearson correlation coefficient by ranking significance of information each feature carries. In some embodiments, the supervised data is also being preprocessed using any suitable data managing technologies, such as data cleaning, label encoding, data sorting, etc.

In some embodiments, the set of supervised data may be imbalanced when there is significant inequality between the number of data from different classes. For example, the set of supervised data includes 100 data. Among the 100 data, there are 90 data are identified, by the one or more identifiers, as normal class (or class negatives). There are 10 data are identified, the one or more identifiers, as abnormal class (or class positives). In this case, the set of 100 data can be considered as imbalanced. In industrial control systems (ICS) that include various industrial components (e.g., devices, networks, and controllers) to automate industrial processes, the majority of data generated by the various industrial components are in the normal class and a minority of data are in the abnormal class. Thus, the ICS usually creates high imbalanced data. It is a challenge to use traditional machine learning methods on the imbalanced data. Most of the traditional machine learning algorithms are designed to obtain high accuracy which tend to overrepresent majority class and misclassify minority class. However, accuracy is not appropriate for evaluating the imbalanced data classification performance. For example, if a dataset holds 1 abnormal sample and 99 normal samples, and the machine learning model incorrectly classifies the 1 abnormal sample as in the normal class, the accuracy of the modeling result can be as high as 99% (e.g., calculated as correctly classified samples divided by all the samples). However, this 99% accuracy does not show the misclassified rate of the 1 abnormal sample. Thus, these traditional modeling tends to be biased towards the majority class (e.g., the normal class) in classifying imbalanced data and underrepresent the minority class (e.g., the abnormal class). The present disclosure provides systems and methods that can auto detect the imbalance industrial data, auto address the imbalance data pattern, and auto apply the best ML model. For example, the process 200 can select the best machine learning model for a set of imbalanced supervised data.

At step 206, a first set of machine learning models are selected. The first set of machine learning models may include any suitable machine learning models that can provide supervised learning. For example, the first set of machine learning models may include, but are not limited to, a Random Forest model, a Decision Tree model (e.g., hierarchical classifiers model), a Bagging model (e.g., bootstrap aggregating model), an Extremely Randomized Trees model, a AdaBoost model, a Nearest Neighbor model, a Neural Network model, and a Naïve Bayes model.

At step 208, each supervised data is being processed using each of the first set of machine learning models. In some embodiments, the set of machine learning models may be processed in parallel. For each supervised data, a first set of classifications are generated by the corresponding first set of machine learning models. A classification is a numerical model output value for a corresponding data. The classification indicates the same features as the one or more identifiers of the data. For example, if the one or more identifiers of a supervised data indicate a good or a bad operating condition of an industrial equipment, a classification generated by a machine learning model for this supervised data indicates either a good or a bad operation condition of the industrial equipment as well. The classification is independent of the one or more identifiers. In other words, the classification from a model may indicate a good operating condition and the one or more identifiers may indicate a bad operating condition for the same supervised data. This is because the machine learning cannot provide 100% accurate result of a supervised data. The present process 200 provides a way to select the best machine learning model for a set of supervised data to increase the modeling accuracy for a given industrial system.

At step 210, an evaluation value is determined for each of the first set of machine learning model. The evaluation value represents an accuracy and/or error rate of a machine learning model. The evaluation value indicates how well a machine learning model correctly classify the data (e.g., normal or good classification, abnormal or bad classification). The evaluation value may be determined by comparing, for each supervised data, the classification to the one or more identifiers. For example, for a supervised data, if the classification indicates a normal condition and the identifiers indicate a normal condition, then the machine learning model has a true negative result. If the classification indicates a normal condition and the identifiers indicate an abnormal condition, then the machine learning model has a false negative result. If the classification indicates an abnormal condition and the identifiers indicate an abnormal condition, then the machine learning model has a true positive result. If the classification indicates an abnormal condition and the identifiers indicate a normal condition, then the machine learning model has a false positive result. The evaluation value may be calculated based on a specificity value, a sensitivity value, and/or a precision value. The sensitivity value indicates how many positive data (e.g., indicated as abnormal data) are correctly classified as positive. The sensitivity value is sensitive to correctly classified positives but not misclassified negatives. The sensitivity value can be calculated by:

$$Sensitivity = \frac{TP}{TP + FN}$$

The specificity value indicates how many negative data (e.g., indicated as normal data) are correctly classified as negative. The specificity value can be calculated by:

$$Specificity = \frac{TN}{TN + FP}$$

The precision value is distribution-dependent since it carries information about how many negative data are misclassified to the positive class but is not sensitive to how many positive samples are misclassified. The precision value can be calculated by:

$$Precision = \frac{TP}{TP + FP}$$

TP (True Positive) indicates a number of data that are labeled as positive and are correctly classified by the model as positive. FN (False Negative) indicates a number of data that are labeled as positive and are incorrectly classified by the model as negative. TN (True Negative) indicates a number of data that are labeled as negative and are correctly classified by the model as negative. FP (False Positive) indicates a number of data that are labeled as negative and are incorrectly classified by the model as positive.
The evaluation value can be calculated using any suitable evaluation metrics. For example, the evaluation value may be calculated using F-Measure value, which can be calculated by:

$$F - Measure = \frac{{( 1 + β )}^{2} \cdot Sensitivity \cdot Precision}{{β}^{2} \cdot Sensitivity \cdot Precision}$$

In another example, the evaluation value may be calculated using a G-Mean value, which can be calculated by:

G-Mean=\sqrt{Sensitivity×Specificity}

The F-Measure value and the G-Mean value are good evaluation metrics for assessing the performance of imbalanced data classification.

At step 212, each of the set of evaluation values is compared with a threshold value. The threshold value is predetermined value for the industrial system. If an evaluation value is larger than the threshold value, the corresponding machine learning model is selected as a candidate. At step 213, if there are more than one model that has an evaluation value larger than the threshold value, the model with the highest evaluation value is selected as the best supervised learning model.

If an evaluation value is less than or equal to the threshold value, the process 200 proceeds to the step 214 and the step 215 in parallel (e.g., simultaneously). In some embodiments, when the evaluation value is less or equal to the threshold value, the analytics systems determine that the set of industrial data are imbalanced. In this way, the analytics systems can detect imbalanced data automatically. At step 214, the set of supervised data is resampled. The resampling may include over-sampling and/or under-sampling. The resampling method can be used to improve the classification performances of machine learning on highly imbalanced datasets by balancing the sample sizes from different classes. Traditionally, methods for balancing the imbalanced data are based on over-sampling and under-sampling approaches. The traditional under-sampling method usually decreases the number of data items from the majority class by removing data within the majority class. The traditional over-sampling method usually increases the number of data items of the minority class by duplicating data items of the minority class. Typically, over-sampling tools are better than under-sampling tools because over-sampling would not arbitrarily eliminate samples that could cause the loss of information. However, the traditional over-sampling tools may cause over-fitting problem by merely mechanically duplicating data items in the minority class. The present disclosure provides systems and methods for over-sampling the minority class data items by generating synthetic data items based on the information of the existing ones rather than repeating the original data items. For example, in an imbalanced set of 100 data, there are 10 data labeled as abnormal and there are 90 data labeled as normal. When the 100 data are resampled, another 80 synthetic data labeled as abnormal are generated based on the information of the original 10 abnormal data and added to the set of data to bring the normal data to 90 and the abnormal data to 90 in order to balance the normal data with abnormal data. The set of supervised data may be resampled by any suitable resampling methods, such as ADASYN method, SMOTE method, etc.

At step 216, processing each of the first set of machine learning models using the resampled set of data. For each of the resampled set of data, a classification is generated. At step 218, similar as in the step 212, an evaluation value is determined for each of the first set of machine learning model.

At step 215, simultaneously proceeded with the step 214, a second set of machine learning models are selected. The second set of machine learning model is different from the first set of machine learning model. The second set of machine learning model includes any suitable models that can provide supervised learning for imbalanced data. For example, the second set of machine learning models may include any suitable ensemble based imbalanced data models, such as Easy Ensemble Classifier model, Balanced Random Classifier model, etc.

At step 217, each of the second set of machine learning models is processed using the set of supervised data. For each of the set of data, a classification is generated. At step 219, similar as in the step 212, an evaluation value is determined for each of the second set of machine learning model.

At step 220, a machine learning model, from a model group including both of the first set of models and the second set of models, that has the highest evaluation value is selected as the best supervised learning model for the industrial system.

FIG. 3 illustrates an exemplary process 300 for selecting a machine learning model for unsupervised industrial data. The process 300 can be operated by any industrial analytics systems, such as, artificial intelligent engines, analytics engines, etc. At step 302, a set of unsupervised data is received. At least some of the set of unsupervised data includes data that does not have any identifiers (e.g., not labeled) that can be used to identify one or more operating conditions or events of the data source for the machine learning. Each unsupervised data may be categorical data or numerical data.

At step 304, the set of unsupervised data is preprocessed. In some embodiments, the step 304 may be omitted. All the categorical data may be converted to numerical data. For example, if a categorical data indicates that the gate is open, this categorical data is converted to a numerical value 1. If a categorical data indicates that the gate is closed, this categorical information is converted to a numerical value 0. The conversion from the categorical data to numerical data can be achieved using any suitable conversion methods, such as a Label Encoding method, a One-hot Encoding method, etc. In some embodiments, the supervised data is also being preprocessed using any suitable data managing technologies, such as data cleaning, label normalization, data filtering, etc.

At step 306, a dimension reduction may be applied to the unsupervised data for visualization purposes. In some embodiments, the step 306 may be omitted. The dimension reduction may be applied using any suitable dimension reduction methods, such as a Principle Component Analysis method, a t-Distributed Stochastic Neighbor Embedding method, etc.

At step 308, a set of machine learning models are selected. The set of machine learning models include a desired number of suitable models that can be used for providing unsupervised learning. For example, the set of machine learning models may include a Principal Component Analysis (PCA) model, a Local Outlier Factor (LOF) model, a Feature Bagging model, a Minimum Covariance Determinant (MCD) model, an Isolation Forest model, a Locally Selective Combination (LSCP) model, a Cluster-based Local Outlier Factor (CBLOF) model, a Histogram-base Outlier Detection (HBOS) model, an One-class SVM (OCSVM) model, an Angle-based Outlier Detector (ABOD) model, a K Nearest Neighbors (KNN) model, an Average KNN model, etc.

At step 310, each of the set of machine learning model is applied to the set of unsupervised data. For each unsupervised data, a classification is generated by a corresponding machine learning model. The classification indicates a featured class which the data belongs to. For example, the classification may indicate a data belongs to a normal class or an abnormal class. For each unsupervised data, a set of classification may be generated by the set of machine learning models.

At step 312, a subset of unsupervised data is determined by including all the data that are classified as a predefined class (e.g., abnormal class) by a percentage/number of machine learning models that is larger than a threshold value. For example, a data that is classified as abnormal by 50% of models within the set of machine learning models may be included in the subset of unsupervised data. In another example, if the set of machine learning model includes 12 models, any data that is classified as abnormal by more than 5 models out of the 12 models may be included in the subset of data.

At step 314, each of the set of machine learning models is evaluated by evaluating the class separability between normal and abnormal data suggested by each model. For example, each model is evaluated based on how many data which the model classifies as abnormal belongs to the subset of data. The evaluation value may be determined using a silhouette coefficient performance metric.

At step 316, one or more machines learning models are selected based on the evaluation values. The set of machine learning models may be ranked based on the evaluation values. A desired number of models that are the ranked highest may be selected and stored for future learning.

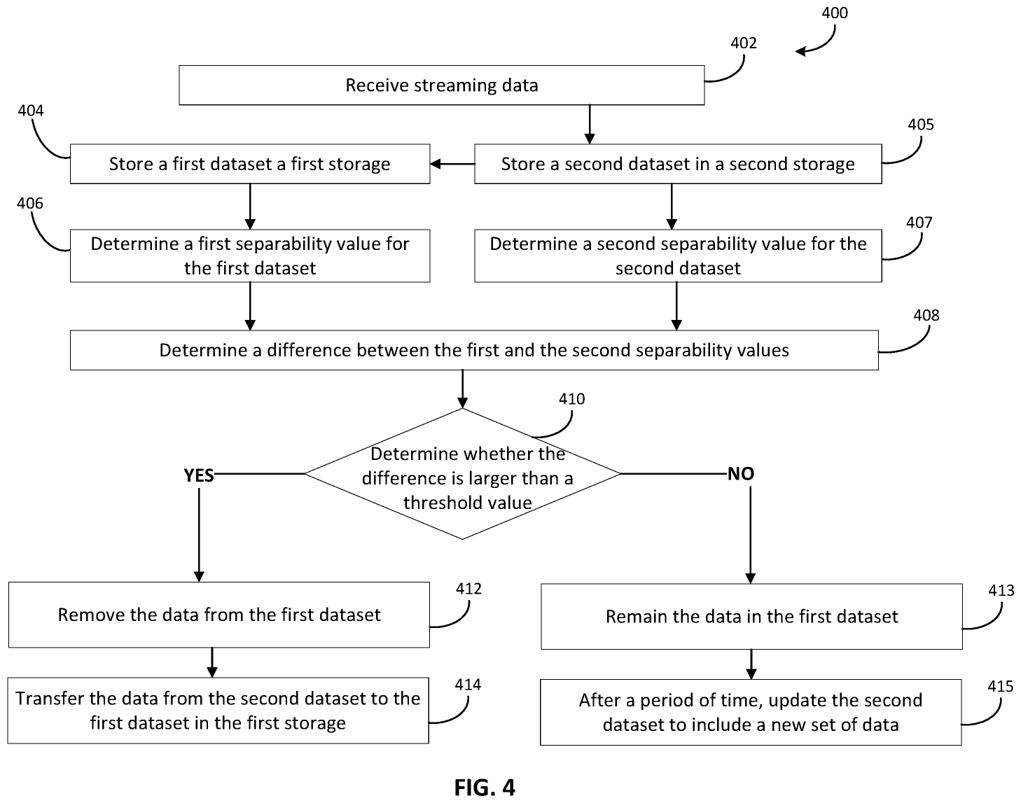

FIG. 4 illustrates an exemplary process 400 for generating a set of industrial data for machine learning in the previously described process 200 and/or process 300. The process 400 can be operated by any industrial analytics systems, such as, artificial intelligent engines, analytics engines, etc. The process 400 can generates up-to-date dataset for machine training through the process 200 and the process 300.

At step 402, streaming data is received. The streaming data may include any type of industrial data, such as Internet of Things (IOT) data or any type of raw industrial data. The streaming data may be assigned, collected, and/or stored in a second dataset within a second storage (e.g., a database). In some embodiments, the second dataset can store a predetermined number of data items. In some embodiments, the second storage updates the second dataset periodically. For example, the second storage receives and stores a set of streaming data in the second dataset at a first time. After a period of time, at a second time, the second storage may update the second dataset by receiving a new set of streaming data and replace the original data in the second dataset with the new set of streaming data. In some embodiments, the second stores a new set of streaming data when the data items of the second dataset are transferred to a first storage or when the second storage is empty. Each of the streaming data item may have one or more dimensions. For example, a streaming data item may have a first dimension including a first value indicating a measurement from a first sensor of an industrial system, and a second dimension including a second value indicating a measurement from a second sensor of the industrial system.

At step 404, a number of data items are stored in a first dataset within the first storage. In some embodiments, first dataset and the second dataset have the same number of data items. In some embodiments, when the first storage is determined as being empty, the data items of the second dataset are transferred from the second storage to the first storage and the second storage receives a new set of data. The first dataset maybe used as the set of supervised data for supervised machine learning in the process 200 of FIG. 2 and/or used as the set of unsupervised data for unsupervised machine learning in the process 300 of FIG. 3.

At step 406, a first separability value is determined for the first dataset. The separability value can be determined using any suitable separability evaluation methods. For example, the separability value may be determined using a silhouette coefficient. A number of clustering models are used for the first dataset. Each clustering model includes a different number of clusters. For example, 3 clustering models are used. A first clustering model arranges the data items of the first dataset into 2 clusters. A second clustering model arranges the data items into 3 clusters. A third clustering model arranges the data into 4 clusters. For each clustering model, a model evaluation value (e.g., a silhouette coefficient value) is calculated. Silhouette coefficient is between −1 to 1. When silhouette coefficient is closer to 1, it means the clusters classified are more compact and therefore is more preferable. The clustering model that generates the highest Silhouette Coefficient value is determined as the first separability value. The cluster number used for the best evaluated clustering model is as a Kink Point. For example, if the silhouette coefficient corresponds to the third clustering model is the smallest, the smallest silhouette coefficient is determined as the first separability value and 5 (clusters) corresponding to the third clustering model is determined as the Kink Point.

At step 407, a second separability value is determined for the second dataset. The second separability value is determined by processing the clustering model with the Kink Point. For example, if the Kink Point for the first dataset is determined as 5, a clustering model with 5 clusters is applied to the second dataset. An evaluation value (e.g., a silhouette coefficient value) is determined for the second dataset. The evaluation value is determined as the second separability value.

At step 408, a difference between the first and the second separability values is determined. At step 410, the difference is compared with a predetermined threshold value. If the difference is larger than or equal to the threshold value, that means the first dataset and the second dataset are significantly different. In this case, at step 412, the data items from the first dataset are removed to empty the first storage. At step 414, the first dataset is updated by transferring the data items from the second dataset to the first dataset. The updated first dataset can be used to retrain a previously trained supervised learning process 200 or unsupervised learning process 300.

If the difference is smaller than the threshold value, that means the first dataset and the second dataset are not significantly different. In this case, at step 413, the data items remain in the first dataset. At step 415, after a period of time, the second dataset is updated to empty the current data items and repeats from the step 402 to store a new set of streaming data.

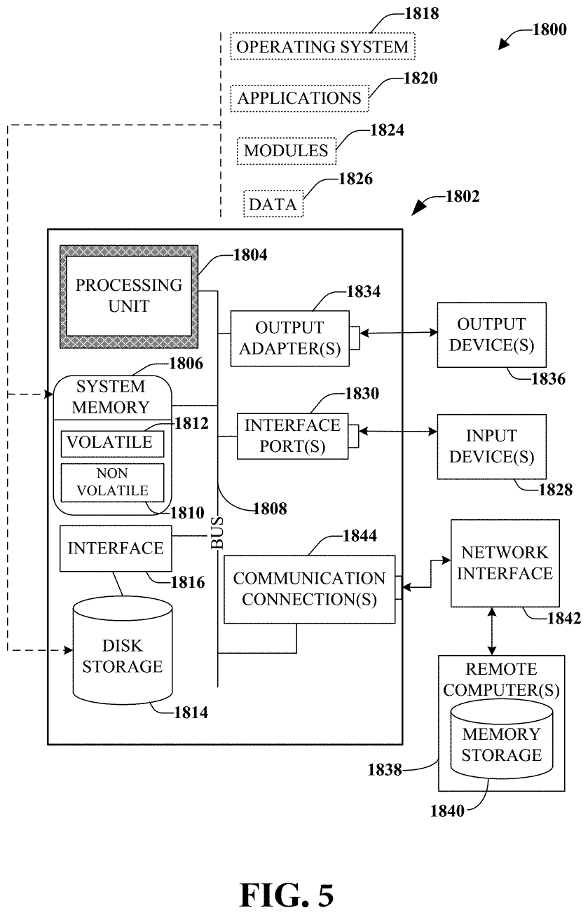

Referring now to FIG. 5, illustrated is a block diagram of a computer operable to execute the disclosed aspects. In order to provide additional context for various aspects, FIG. 5 and the following discussion are intended to provide a brief, general description of a suitable computing environment 1800 in which the various aspects of the embodiment(s) can be implemented. While the description above is in the general context of computer-executable instructions that may run on one or more computers, those skilled in the art will recognize that the various embodiments can be implemented in combination with other program modules and/or as a combination of hardware and software.

Generally, program modules include routines, programs, components, data structures, etc., that perform particular tasks or implement particular abstract data types. Moreover, those skilled in the art will appreciate that the disclosed aspects can be practiced with other computer system configurations, including single-processor or multiprocessor computer systems, single-board computers, minicomputers, mainframe computers, as well as personal computers, hand-held computing devices, microprocessor-based or programmable consumer electronics, micro-controllers, embedded controllers, multi-core processors, and the like, each of which can be operatively coupled to one or more associated devices.

The illustrated aspects of the various embodiments may also be practiced in distributed computing environments where certain tasks are performed by remote processing devices that are linked through a communications network. In a distributed computing environment, program modules can be located in both local and remote memory storage devices. A computing platform can host or permit processing of all or many distinct logical agents. Alternatively, each agent may operate in a separate, networked processor that is centrally located or possibly located, or integrated with, the process or process equipment that it manages (e.g., a single-board computer running an oven agent may be embedded in an oven controller). Various degrees of centralized processing and distributed processing may be implemented.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, DRAM, flash memory, memory sticks or solid state memory, or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

With reference again to FIG. 5, the illustrative environment 1800 for implementing various aspects includes a computer 1802, which includes a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors, custom processors, custom integrated-circuits, multi-core processor arrays, analog processors, pipeline processors, and other multi-processor architectures may also be employed as the processing unit 1804.

The system bus 1808 can be any of several types of bus structure that may further interconnect to a memory bus (with or without a memory controller), a peripheral bus, and a local bus using any of a variety of commercially available bus architectures. The system memory 1806 includes read-only memory (ROM) 1810 and random access memory (RAM) 1812. A basic input/output system (BIOS) is stored in a non-volatile memory 1810 such as ROM, EPROM, EEPROM, which BIOS contains the basic routines that help to transfer information between elements within the computer 1802, such as during start-up. The RAM 1812 can also include a high-speed RAM such as static RAM for caching data.

The computer 1802 further includes a disk storage 1814, which can include an internal hard disk drive (HDD) (e.g., EIDE, SATA), which internal hard disk drive may also be configured for external use in a suitable chassis (not shown), a magnetic floppy disk drive (FDD), (e.g., to read from or write to a removable diskette) and an optical disk drive (e.g., reading a CD-ROM disk or, to read from or write to other high capacity optical media such as the DVD). The hard disk drive, magnetic disk drive and optical disk drive can be connected to the system bus 1808 by a hard disk drive interface, a magnetic disk drive interface and an optical drive interface, respectively. The interface 1816 for external drive implementations includes at least one or both of Universal Serial Bus (USB) and IEEE 1094 interface technologies. Other external drive connection technologies are within contemplation of the various embodiments described herein.

The drives and their associated computer-readable media provide nonvolatile storage of data, data structures, computer-executable instructions, and so forth. For the computer 1802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the disclosed aspects.

A number of program modules can be stored in the drives and RAM, including an operating system 1818, one or more application programs 1820, other program modules 1824 including one or more analytics systems, and program data 1826. All or portions of the operating system, applications, modules, and/or data can also be cached in the RAM. It is to be appreciated that the various embodiments can be implemented with various commercially available operating systems or combinations of operating systems or may be implemented without an operating system.

A user can enter commands and information into the computer 1802 through one or more wired/wireless input devices 1828, such as a keyboard and a pointing device, such as a mouse. Other input devices (not shown) may include a microphone, an IR remote control, a joystick, a game pad, a stylus pen, touch screen, or the like. These and other input devices are often connected to the processing unit 1804 through an input device (interface) port 1830 that is coupled to the system bus 1808, but can be connected by other interfaces, such as a parallel port, an IEEE 1094 serial port, a game port, a USB port, an IR interface, etc. Additionally, the interface ports 1830 may include one or more channels of digital and/or analog input. The interface ports for analog signals will receive for example a voltage input coming from a process sensor such as a temperature sensor. The voltage input to the interface ports 1830 from the temperature sensor may vary linearly with the temperature of the sensor. The interface port will generate a digital value that corresponds to the voltage presented to the interface ports. The digital representation of the sensor value will be processed, averaged, or filtered as needed for use by applications 1820 and/or modules 1824. The interface ports may also receive digital inputs such from a switch or a button and similarly provide this digital value to applications 1820 and/or modules 1824.

A monitor or other type of display device is also connected to the system bus 1808 via an output (adapter) port 1834, such as a video adapter. In addition to the monitor, a computer typically includes other peripheral output devices 1836, such as speakers, printers, etc. The output adapters may also provide one or more digital and/or analog values for use by display, control, or other computer-based devices. For example, the output adapter 1834 could provide a voltage signal between about 0 volts and 10 volts that correspond to the desired speed of a mixing motor such that about 0 volts corresponds to around 0 rpm (revolutions per minute) and about 10 volts corresponds to around 1200 rpm.

The computer 1802 may operate in a networked environment using logical connections via wired and/or wireless communications to one or more remote computers, such as a remote computer(s) 1838. The remote computer(s) 1838 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1840 is illustrated. Multiple computers may operate in an integrated manner to control a single (e.g., multi-step) production process. Process control tasks may be distributed across multiple computers. For example, an agent-based control architecture may have all the agents reside in a single computer-based controller or may have several or more agents reside in several computer-based controllers, or have each agent reside in a separate computer-based controller.

The remote computer(s) can have a network interface 1842 that enables logical connections to computer 1802. The logical connections include wired/wireless connectivity to a local area network (LAN) and/or larger networks, e.g., a wide area network (WAN). Such LAN and WAN networking environments are commonplace in offices and companies, and facilitate enterprise-wide computer networks, such as intranets, all of which may connect to a global communications network, e.g., the Internet.

When used in a LAN networking environment, the computer 1802 is connected to the local network through a wired and/or wireless communication network interface or adapter (communication connection(s)) 1844. The adaptor 1844 may facilitate wired or wireless communication to the LAN, which may also include a wireless access point disposed thereon for communicating with the wireless adaptor.

When used in a WAN networking environment, the computer 1802 can include a modem, or is connected to a communications server on the WAN, or has other means for establishing communications over the WAN, such as by way of the Internet. The modem, which can be internal or external and a wired or wireless device, is connected to the system bus 1808 via the serial port interface. In a networked environment, program modules depicted relative to the computer 1802, or portions thereof, can be stored in the remote memory/storage device 1840. It will be appreciated that the network connections shown are illustrative and other means of establishing a communications link between the computers can be used.

The computer 1802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, and so forth), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

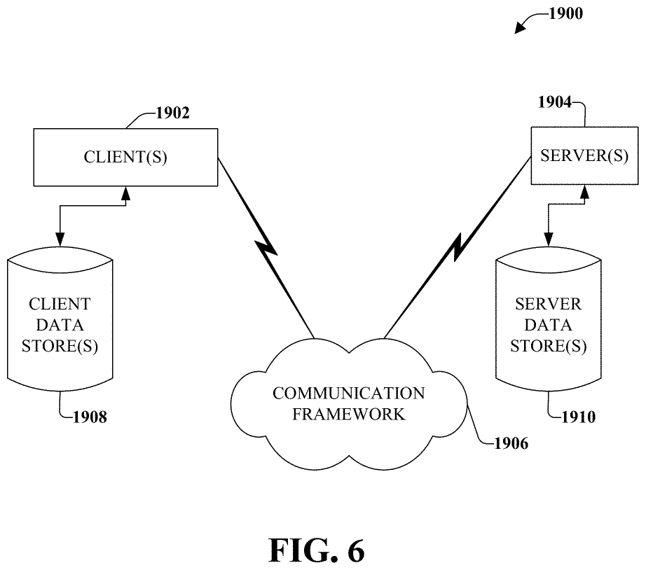

Referring now to FIG. 6, a schematic block diagram of an illustrative computing environment 1900 for processing the disclosed architecture is illustrated in accordance with another aspect. The environment 1900 includes one or more client(s) 1902. The client(s) 1902 can be hardware and/or software (e.g., threads, processes, computing devices). The client(s) 1902 can house cookie(s) and/or associated contextual information in connection with the various embodiments, for example.

The environment 1900 also includes one or more server(s) 1904. The server(s) 1904 can also be hardware and/or software (e.g., threads, processes, computing devices). The servers 1904 can house threads to perform transformations in connection with the various embodiments, for example. One possible communication between a client 1902 and a server 1904 can be in the form of a data packet adapted to be transmitted between two or more computer processes. The data packet may include a cookie and/or associated contextual information, for example. The environment 1900 includes a communication framework 1906 (e.g., a global communication network such as the Internet) that can be employed to facilitate communications between the client(s) 1902 and the server(s) 1904.

Communications can be facilitated via a wired (including optical fiber) and/or wireless technology. The client(s) 1902 are operatively connected to one or more client data store(s) 1908 that can be employed to store information local to the client(s) 1902 (e.g., cookie(s) and/or associated contextual information). Similarly, the server(s) 1904 are operatively connected to one or more server data store(s) 1910 that can be employed to store information local to the servers 1904.

The various techniques described herein may be implemented in connection with hardware or software or, where appropriate, with a combination of both. As used in this application, the terms “component”, “module”, “object”, “service”, “model”, “representation”, “system”, “interface”, or the like are generally intended to refer to a computer-related entity, either hardware, a combination of hardware and software, software, or software in execution. For example, a component can be, but is not limited to being, a process running on a processor, a processor, a hard disk drive, a multiple storage drive (of optical and/or magnetic storage medium), an object, an executable, a thread of execution, a program, and/or a computer. By way of illustration, both an application running on a controller and the controller can be a component. One or more components can reside within a process and/or thread of execution and a component can be localized on one computer and/or distributed between two or more computers, industrial controllers, or modules communicating therewith. As another example, an interface can include I/O components as well as associated processor, application, and/or API components.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit, and scope in accordance with the appended claims.

The subject matter as described above includes various exemplary aspects. However, it should be appreciated that it is not possible to describe every conceivable component or methodology for purposes of describing these aspects. One of ordinary skill in the art may recognize that further combinations or permutations may be possible. Various methodologies or architectures may be employed to implement the subject invention, modifications, variations, or equivalents thereof. Accordingly, all such implementations of the aspects described herein are intended to embrace the scope and spirit of subject claims.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A non-transitory computer-readable medium comprising computer-executable instructions that, when executed, are configured to cause a processor to perform operations comprising:
receiving a set of industrial data associated with one or more industrial components within an industrial system;
generating a classification for each of the set of industrial data using each of a set of models;
generating an evaluation value for each of the set of models based on the classifications for each industrial data; and
selecting one or more models according to the evaluation values.

2. The non-transitory computer-readable medium of claim 1, wherein the set of models are a set of machine learning models for making predictions of the industrial system using industrial data.

3. The non-transitory computer-readable medium of claim 1, wherein the set of industrial data are supervised data, each supervised data including one or more identifiers identifying one or more operating conditions of the industrial system.

4. The non-transitory computer-readable medium of claim 3, wherein the operations comprise:
determining, for each evaluation value, whether the evaluation value is larger than a threshold value; and
in response to determining that the evaluation value is larger than the threshold value, selecting the corresponding machine learning model.

5. The non-transitory computer-readable medium of claim 4, wherein the operations comprise:
in response to determining that the evaluation value is less than or equal to the threshold value,
applying resampling to the set of industrial data;
generating a classification for each of the resampled set of industrial data using each of the set of models; and
generating an evaluation value for each of the set of models based on the classifications for each of the resampled industrial data.

6. The non-transitory computer-readable medium of claim 5, wherein the operations comprise:
generating a classification for each of the set of industrial data using each of a second set of models, wherein the second set of models comprises one or more models for imbalanced data; and
generating an evaluation value for each of the second set of models based on the classifications for each of the set of industrial data.

7. The non-transitory computer-readable medium of claim 6, wherein the operations comprise:
selecting one or more models, from a model group including the set of models and the second set of models, that have the highest evaluation values.

8. The non-transitory computer-readable medium of claim 1, wherein the set of industrial data are unsupervised data, wherein each unsupervised data does not include any identifiers identifying one or more operating conditions of the industrial system.

9. The non-transitory computer-readable medium of claim 8, wherein the operations comprise:
determining a subset of data, from the set of industrial data, that are classified as abnormal data by a percentage of models larger than a threshold value; and
selecting one or more models that predicted the most data within the subset of industrial data.

10. A method, comprising:
receiving a set of industrial data associated with one or more industrial components within an industrial system;
generating a classification for each of the set of industrial data using each of a set of models;
generating an evaluation value for each of the set of models based on the classifications for each industrial data; and
selecting one or more models according to the evaluation values.

11. The method of claim 10, wherein the set of models are a set of machine learning models for making predictions of the industrial system using industrial data.

12. The method of claim 10, wherein the set of industrial data are supervised data, each supervised data including one or more identifiers identifying one or more operating conditions of the industrial system.

13. The method of claim 12, further comprises:
determining, for each evaluation value, whether the evaluation value is larger than a threshold value; and
in response to determining that the evaluation value is larger than the threshold value, selecting the corresponding machine learning model.

14. The method of claim 13, further comprises:
in response to determining that the evaluation value is less than or equal to the threshold value,
applying resampling to the set of industrial data;
generating a classification for each of the resampled set of industrial data using each of the set of models; and
generating an evaluation value for each of the set of models based on the classifications for each of the resampled industrial data.

15. The method of claim 14, further comprises:
generating a classification for each of the set of industrial data using each of a second set of models, wherein the second set of models comprises one or more models for imbalanced data; and
generating an evaluation value for each of the second set of models based on the classifications for each of the set of industrial data.

16. The method of claim 15, further comprises:
selecting one or more models, from a model group including the set of models and the second set of models, that have the highest evaluation values.

17. The method of claim 10, wherein the set of industrial data are unsupervised data, wherein each unsupervised data does not include any identifiers identifying one or more operating conditions of the industrial system.

18. The method of claim 17, further comprises:
determining a subset of data, from the set of industrial data, that are classified as abnormal data by a percentage of models larger than a threshold value; and
selecting one or more models that predicted the most data within the subset of industrial data.

19. A system comprising:
a memory that stores executable components; and
a processor, operatively coupled to the memory, that executes the executable components, the executable components comprising:
receiving a set of industrial data associated with one or more industrial components within an industrial system;
generating a classification for each of the set of industrial data using each of a set of models;
generating an evaluation value for each of the set of models based on the classifications for each industrial data; and
selecting one or more models according to the evaluation values.

20. The system of claim 19, wherein the set of industrial data include unsupervised data and unsupervised data, wherein each supervised data includes one or more identifiers identifying one or more operating conditions of the industrial system.
